(19) United States
(12) Patent Application Publication
(10) Pub. No.: US 2009/0292866 A1
(43) Pub. Date: Nov. 26, 2009

(54) DISK APPARATUS AND COMMAND PROCESSING METHOD

(75) Inventor: Kimiyasu Aida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/359,976

(22) Filed: Jan. 26, 2009

(30) Foreign Application Priority Data
May 26, 2008 (JP) 2008-136172

(51) Int. Cl. G06F 12/00

(52) U.S. Cl. 711/112; 711/E12.001

(57) ABSTRACT

A control unit in a disk apparatus stores a command in a queue. When the execution of the command stored in the queue is not completed within a predetermined time, the control unit stores an LBA corresponding to a command which is executed within the predetermined time and during execution of which the disk retry is generated more than a predetermined number of times, as a monitoring object LBA in a monitoring object LBA management table. Further, when an LBA corresponding to an execution object command corresponds to the monitoring object LBA stored in the monitoring object LBA management table, the control unit rearranges the command in the position at the end of the queue.

### CROSS-REFERENCE TO RELATED APPLICATIONS

This application is based upon and claims the benefit of priority of the prior Japanese Patent Application No. 2008-136172, filed on May 26, 2008, the entire contents of which are incorporated herein by reference.

### FIELD

The embodiments discussed herein are related to a disk apparatus and a command processing method that suppress occurrence of a time-out of a command.

### BACKGROUND

As a conventional command processing technique, there is proposed a disk apparatus which, when an error occurs during execution of a command, returns the command under execution to a command queue, and which selects a command to be executed next from execution waiting commands (see, for example, Japanese Laid-Open Patent Publication No. 2001-100935).

Further, there is proposed a reordering controller which performs command rearrangement processing according to a state of recovery processing in a storage apparatus (see, for example, Japanese Laid-Open Patent Publication No. 2002-304823).

In recent years, in a disk apparatus, it has become difficult to maintain data quality due to an increase in the recording density on a medium surface according to an increase in the capacity of the apparatus. For this reason, at the time of occurrence of an error, the error recovery based on disk retry (error retry) processing is emphasized, so that the disk retry processing time is increased. On the contrary, the performance of a host computer, which requires the disk apparatus to execute a command, has been improved. Therefore, it is required to shorten the command processing time of the disk apparatus.

When the disk apparatus continuously executes the disk retry processing for the error recovery, a command timeout frequently occurs in the host computer, so that the host computer executes the command abort processing and the command reissue processing. This results in a problem that the processing load of the host computer is excessively increased.

Further, the disk apparatus usually executes commands in the order in which the commands can be most efficiently accessed by the disk apparatus based on the logical block addresses (LBA) of the commands. However, according to the analysis of the present inventors, it was found that the disk retry is not taken into account in the algorithm for executing the command. Therefore, in the case where an error occurs in the processing to execute a command corresponding to a certain LBA, when the execution time of the disk retry processing is increased, even a command which is to be executed after the error occurrence command and which may normally return a response (command corresponding to the other LBA) is also regarded as an object of command timeout processing.

The host computer sets, for example, a disk apparatus in which the accumulated number of times of detection of the command timeout has reached a threshold value, as an object to be replaced, and separates the disk apparatus from the host computer. Therefore, there arises a problem that the number of times of occurrence of the command timeout is increased due to the disk retry which frequently occurs at a specific LBA, so that the disk apparatus is separated from the host computer.

FIG. 11 is a diagram for explaining the problem of command processing in the disk apparatus. Reference characters CMD#1 to CMD#N in FIG. 11 denote commands transmitted from a host computer to a disk apparatus. Further, reference character X#1 denotes a time stamp representing the issue time of CMD#1. Reference character X#2 denotes a time stamp representing the issue time of CMD#2. Reference character X#3 denotes a time stamp representing the issue time of CMD#3. Reference character X#4 denotes a time stamp representing the issue time of CMD#4. Reference character X#N denotes a time stamp representing the issue time of CMD#N. It is assumed that CMD#2 is a command corresponding to the LBA at which the disk retry frequently occurs. As illustrated by #A in FIG. 11, the disk apparatus executes CMD#1 at time t1, and as illustrated by #B, the disk apparatus executes CMD#2 at time t2. An execution error of CMD#2 occurs at time t3, so that disk apparatus executes disk retry processing as illustrated by #C. For example, when it takes time to execute the disk retry processing, such as when the disk retry processing is not completed until time t4 in the diagram, CMD#3, CMD#4 and CMD#N which are commands to be executed after CMD#2 are set in the state of command timeout.

### SUMMARY

The disk apparatus of an embodiment of the present invention is a disk apparatus. The disk apparatus comprises a first storage unit, and a control unit that stores the command in a queue and taking out a command stored at the top of the queue to execute the taken-out command as an execution object command. The control unit monitors a stay time of the command stored in the queue, in the control unit, stores, when the execution of the command is not completed within a predetermined time, a logical block address corresponding to a command which is executed within the predetermined time and during execution of which disk retry is generated more than a predetermined number of times, as a monitoring object address in first storage unit. The control unit determines whether or not a command to be executed after the execution of the execution object command is stored in the queue, and determines, when the control unit determines that the command to be executed after the execution of the execution object command is stored in the queue, whether or not the logical block address corresponding to the execution object command corresponds to the monitoring object address stored in the first storage unit. The control unit rearranges, when the control unit determines that the logical block address corresponding to the execution object command corresponds to the monitoring object address stored in the first storage unit command, the command in the position at the end of the queue.

The command processing method of an embodiment of the present invention is a command processing method in a disk apparatus including a disk and control unit executing a command to the disk. The command processing method comprises, in the control unit, storing the command in a queue, and taking out a command stored at the top of the queue to execute the taken-out command as an execution object command, monitoring a stay time of the command stored in the queue, in the control unit, and storing, when the execution of the command is not completed within a predetermined time, a logical block address corresponding to a command which is executed within the predetermined time and during execution of which disk retry is generated more than a predetermined number of times, as a monitoring object address in first storage unit, determining whether or not a command to be executed after the execution object command is stored in the queue, and determining, when the control unit determines that the command to be executed after the execution object command is stored in the queue, whether or not the logical block address corresponding to the execution object command corresponds to the monitoring object address stored in the first storage unit, and rearranging, when the control unit determines that the logical block address corresponding to the execution object command corresponds to the monitoring object address stored in the first storage unit, the command in the position at the end of the queue.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a hardware structure of a disk apparatus according to the present embodiment;

FIG. 2 is a diagram illustrating an example of a functional block diagram of a control unit;

FIG. 3 is a diagram illustrating an example of storing commands in a queue;

FIG. 4 is a diagram illustrating an example of a monitoring object LBA;

FIGS. 5 and 6 are diagrams illustrating an example of a flow of command process;

FIG. 7 is a diagram for explaining the detail of command rearrangement process;

FIG. 8 is a diagram for explaining the detail of command timeout detection process;

FIG. 9 is a diagram for explaining the detail of registration process of the monitoring object LBA;

FIG. 10 is a diagram illustrating an example of application of a command process method; and

FIG. 11 is a diagram for explaining a problem of the command process in the disk apparatus;

### DESCRIPTION OF EMBODIMENT (S)

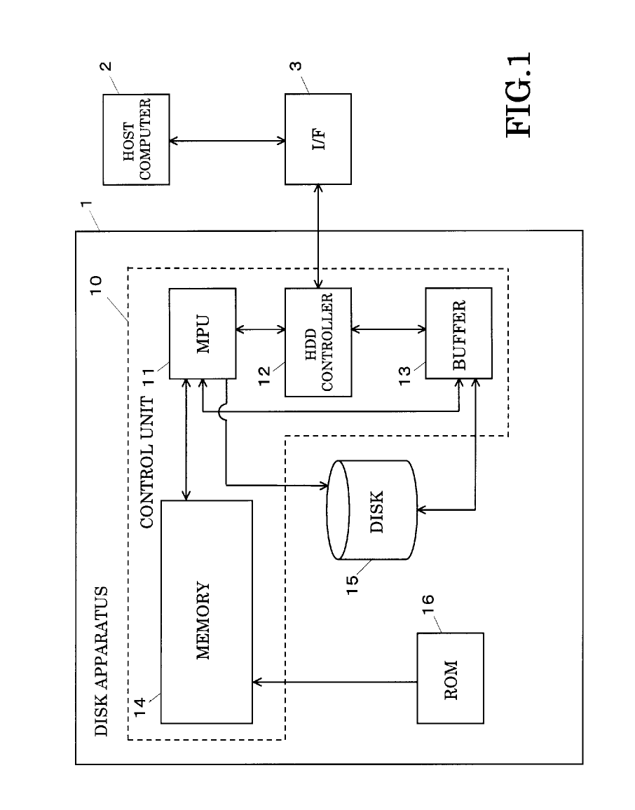

FIG. 1 is a diagram illustrating an example of a hardware structure of a disk apparatus according to the present embodiment. A disk apparatus 1 illustrated in FIG. 1 includes an MPU (Micro Processing Unit) 11, an HDD (Hard Disk Drive) controller 12, a buffer 13, a memory 14, a disk 15, and a ROM 16. A host computer (hereinafter referred to as host) 2 issues a command to transmit a command to the disk apparatus 1 via an interface (IF), and requires the disk apparatus 1 to execute the command. The command issued by the host 2 is, for example, a command (write command) for writing data to the disk 15, or a command (read command) for reading data from the disk 15.

The MPU 11 instructs the HDD controller 12 to execute processing of a command obtained by command rearrangement processing as will be described below, according to a command process program stored in the memory 14 as will be described below.

The HDD controller 12 executes writing (write command)/reading (read command) of data to/from the disk 15 via the buffer 13.

The buffer 13 is storage unit for storing a command, data and so on. The command process program to realize a command processing method according to the present embodiment is loaded to the memory 14. The disk 15 is a magnetic recording medium serving as an object of a command to be executed by the HDD controller 12. The disk 15 includes a user area and a system area. The user area is an area for storing data serving as an object of a command transmitted to the disk apparatus 1 from the host 2. The system area is a nonvolatile storage area for storing a monitoring object LBA as will be described below. When the monitoring object LBA is stored in the system area, the monitoring object LBA is stored in the disk apparatus 1 without being erased even during the period in which the power source of the disk apparatus 1 is turned off.

The monitoring object LBA is an LBA corresponding to a command during execution of which the disk retry is occurred a predetermined number of times or more. In the ROM 16, the command process program is stored beforehand. The command process program stored in the ROM 16 is loaded in the memory 14 at the time when the power source of the disk apparatus 1 is turned on. A control unit 10 to realize the command processing method according to the present embodiment includes the MPU 11, the HDD controller 12, the buffer 13, and the memory 14.

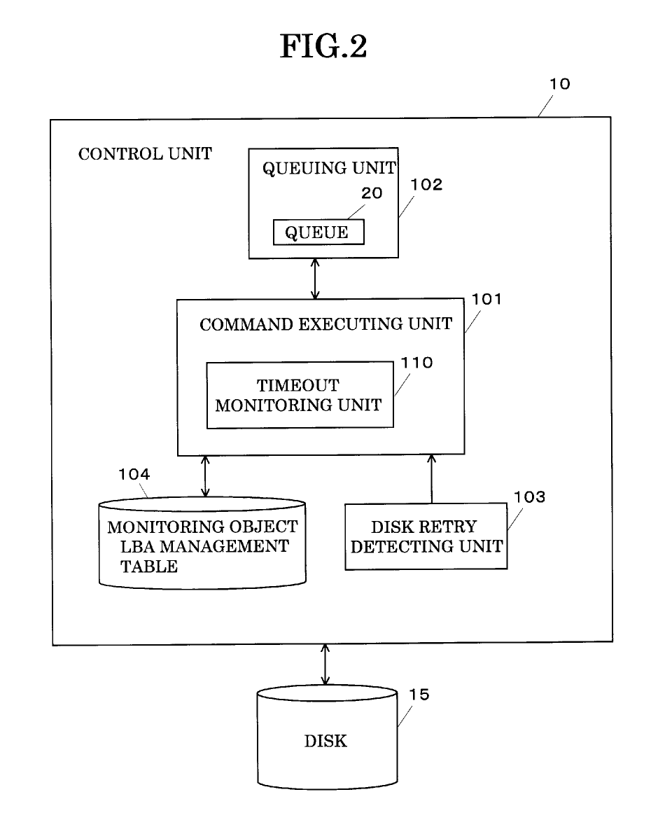

FIG. 2 is a diagram illustrating an example of a functional block diagram of the control unit illustrated in FIG. 1. The control unit 10 includes a command executing unit 101, a queuing unit 102, a disk retry detecting unit 103, and a monitoring object LBA management table 104.

The command executing unit 101 executes a command to the disk 15. Specifically, the command executing unit 101 instructs the queuing unit 102 to store a command transmitted from the host 2 illustrated in FIG. 1 in a predetermined queue 20, and successively takes out a command from the top of the queue 20, and executes the taken-out command as an execution object command. The command executing unit 101 monitors a stay time of the command transmitted from the host 2. When the execution of the command is not completed within a predetermined time, the command executing unit 101 stores, as a monitoring object address (monitoring object LBA), an LBA corresponding to a command which is executed within the predetermined time and during execution of which the disk retry is generated more than a predetermined number of times, in the monitoring object LBA management table 104. The stay time of a command is an elapsed time after the command is received from the host 2 by the control unit 10 until the present time. Specifically, a timeout monitoring unit 110 included in the command executing unit 101 determines whether or not the stay time of the command exceeds the predetermined time. Further, the command executing unit 101 determines whether or not the number of times of the occurrence of disk retry exceeds the predetermined number of times, based on the detection result of the occurrence of disk retry from the disk retry detecting unit 103 as will be described below.

Further, the command executing unit 101 determines whether or not a command to be executed after the execution of the execution object command, is stored in the queue 20. When the command executing unit 101 determines that the command to be executed after the execution of the execution object command is stored in the queue 20, the command executing unit 101 determines whether or not the LBA corresponding to the execution object command corresponds to the monitoring object LBA stored in the monitoring object LBA management table 104. When the command executing unit 101 determines that the LBA corresponding to the execution object command corresponds to the monitoring object LBA, the command executing unit 101 rearranges the command in the position at the end of the queue 20. The command (command which corresponds to the monitoring object LBA and during execution of which the disk retry is generated the predetermined number of times or more) is rearranged in the position at the end of the queue 20, so that the execution of the command is postponed.

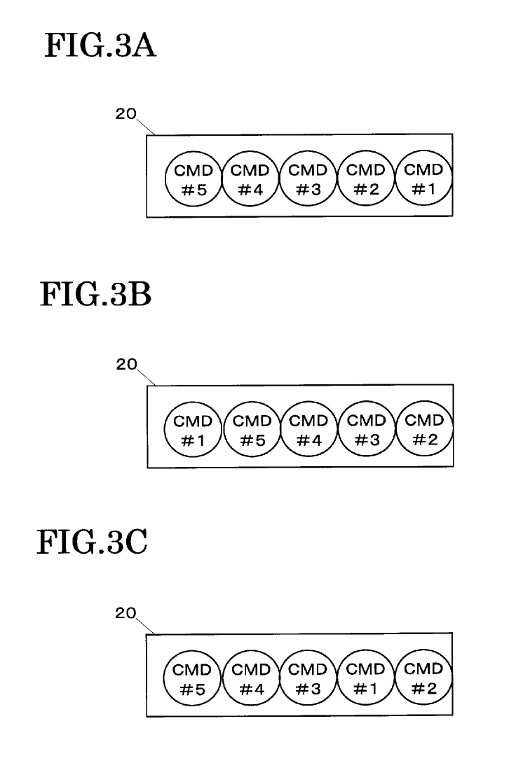

For example, as illustrated in FIG. 3A, it is assumed that commands of CMD#1, CMD#2, CMD#3, CMD#4 and CMD#5 are stored in this order in the queue 20 with the command CMD#1 as the top. The command CMD#1 is the execution object command at present. When CMD#1 corresponds to the monitoring object LBA, the control unit 10 rearranges CMD#1 in the position at the end of the queue 20. As a result, the commands in the queue 20 are arranged in the order of CMD#2, CMD#3, CMD#4, CMD#5 and CMD#1, as illustrated in FIG. 3B.

The queuing unit 102 stores in the queue 20 the command transmitted from the host 2. The disk retry detecting unit 103 detects the occurrence of disk retry based on the interruption caused by the occurrence of disk retry (error retry) from the disk 15, and notifies the detection result to the command executing unit 101. The monitoring object LBA is stored in the monitoring object LBA management table 104.

According to an embodiment of the present invention, when the control unit 10 determines that the LBA corresponding to the execution object command corresponds to the monitoring object LBA, the control unit 10 may select a command that includes a command type different from the command type of the execution object command and that is stored in the queue 20 in correspondence with the logical block address overlapping with the monitoring object address, as a selection command from the commands stored in the queue 20, and may rearrange the execution object command in the position immediately before the selection command in the queue 20. The command type indicates whether or not the command is a write command or a read command.

For example, it is assumed that among the commands stored in the queue 20 in FIG. 3A, CMD#1, CMD#2 and CMD#4 are read commands and CMD#3 and CMD#5 are write commands. Further, it is also assumed that the range of LBA corresponding to CMD#3 overlaps with the range of LBA corresponding to CMD#1, and that the range of LBA corresponding to CMD#5 does not overlap with the range of LBA corresponding to CMD#1.

In the storage example of the commands illustrated in FIG. 3A, when CMD#1 which is the execution object command at present is the monitoring object LBA, the control unit 10 selects CMD#3 which includes a command type different from a command type of CMD#1 and which corresponds to the range of LBA overlapping with the range of LBA corresponding to CMD#1, as a selection command from among CMD#2 to CMD#5. Then, the control unit 10 rearranges CMD#1 in the position immediately before CMD#3 in the queue 20. As a result, the commands in the queue 20 are arranged in the order of CMD#2, CMD#1, CMD#3, CMD#4 and CMD#5, as illustrated in FIG. 3C.

The control unit 10 rearranges the execution object command in the position immediately before the selection command. Therefore, it is possible to prevent that the result of command execution after the rearrangement of the position of the command becomes inconsistent with the result of command execution required by the host 2. For example, when the commands are stored in the queue 20 in the order as illustrated in FIG. 3A at the beginning, it is seen that for the LBA corresponding to CMD#1 and CMD#3, the host 2 required data to be read by CMD#1 and thereafter required data to be written by CMD#3. As illustrated in FIG. 3C, the control unit 10 rearranges CMD#1, which is the read command, in the position immediately before CMD#3 which is the write command. Thereby, data is read by CMD#1 and thereafter data is written by CMD#3 in the LBA corresponding to CMD#1 and CMD#3. Therefore, the execution result of CMD#1 and CMD#3 is not inconsistent with the execution result originally required by the host 2.

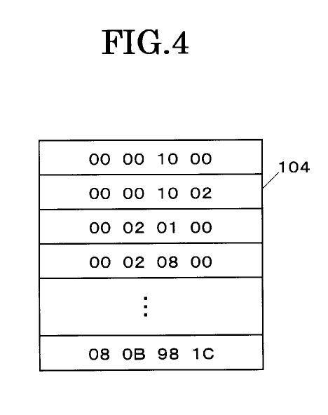

FIG. 4 is a diagram illustrating an example of the monitoring object LBA stored in the monitoring object LBA management table. The monitoring object LBA management table 104 is expressed, for example, by an array in four byte form. The command executing unit 101 stores the monitoring object LBA in each record (storage area for one line) of the monitoring object LBA management table 104 illustrated in FIG. 4.

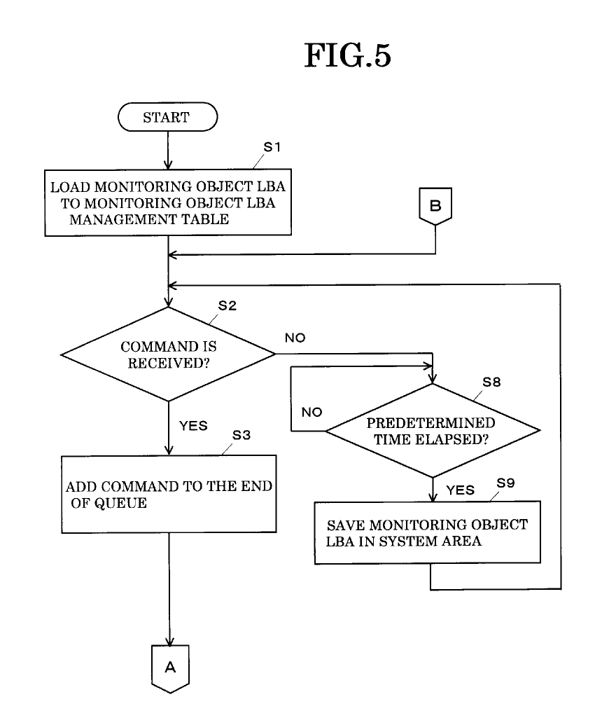

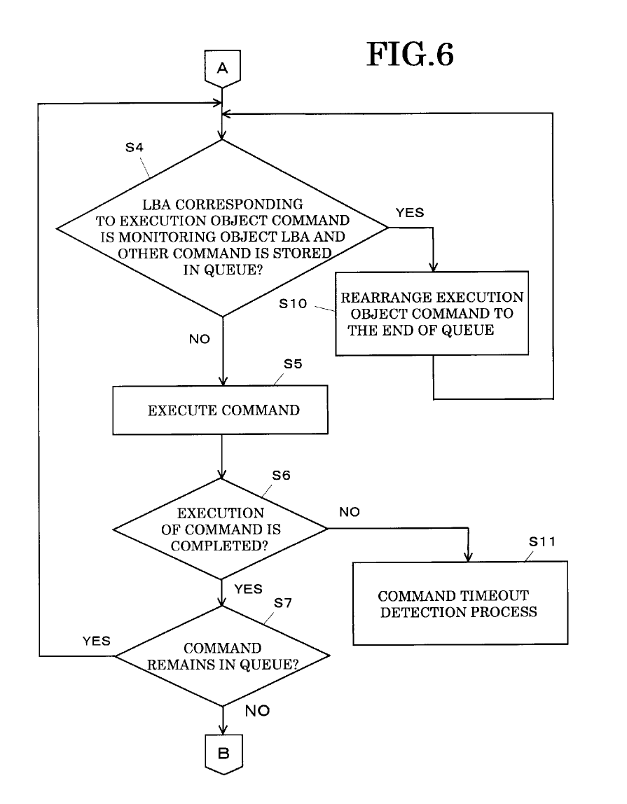

FIGS. 5 and 6 are diagrams illustrating an example of a flow of command process executed by the disk apparatus according to the present embodiment. First, in step S1 in FIG. 5, the power source of the disk apparatus is turned on, and the control unit 10 loads the monitoring object LBA stored in the system area of the disk 15 before the turning off of the power source of the disk apparatus 1, from the system area to the monitoring object LBA management table 104 (step S1). Note that the control unit 10 may load the monitoring object LBA not from the system area of the disk 15 but from arbitrary nonvolatile storage unit in which the monitoring object LBA is stored. The control unit 10 determines whether or not the control unit 10 receives a command from the host 2 (step S2). When the control unit 10 determines that the control unit 10 received the command from the host 2, the process proceeds to step S3. When the control unit 10 determines that the control unit 10 received no command from the host 2, the control unit 10 determines whether or not a predetermined time has elapsed (step S8). When the control unit 10 determines that the predetermined time has not elapsed, the process returns to the step S8. When the control unit 10 determines that the predetermined time has elapsed, the control unit 10 saves the monitoring object LBA in the system area of the disk 15 from the monitoring object LBA management table 104 (step S9), and the process returns to the step S2. Note that the control unit 10 may also be configured so as to store the monitoring object LBA not in the system area of the disk 15 but in arbitrary nonvolatile storage unit. In the step S3, the control unit 10 adds the received command to the end of the queue 20 (step S3), and the process proceeds to step S4 in FIG. 6.

In step S4 in FIG. 6, the control unit 10 determines whether the LBA corresponding to the execution object command (command stored in the top of the queue 20) is the monitoring object LBA, and the other command to be executed after the execution of the execution object command is stored in the queue 20 (step S4).

When the control unit 10 determines that the LBA corresponding to the execution object command is the monitoring object LBA and that the other command to be executed after the execution of the execution object command is stored in the queue 20, the control unit 10 rearranges the execution object command at the end of the queue 20 (step S10), and the process returns to the step S4.

When the control unit 10 determines that the LBA corresponding to the execution object command is not the monitoring object LBA, or that the other command to be executed after the execution of the execution object command is not stored in the queue 20, the control unit 10 executes the execution object command (step S5). The control unit 10 determines whether or not the execution of the command is completed (step S6). When the control unit 10 determines that the execution of the command is completed, the control unit 10 determines whether a command remains in the queue 20 (step S7). When the control unit 10 determines that a command remains in the queue 20, the process returns to the step S4. When the control unit 10 determines that no command remains in the queue 20, the process returns to the step S2 in FIG. 5.

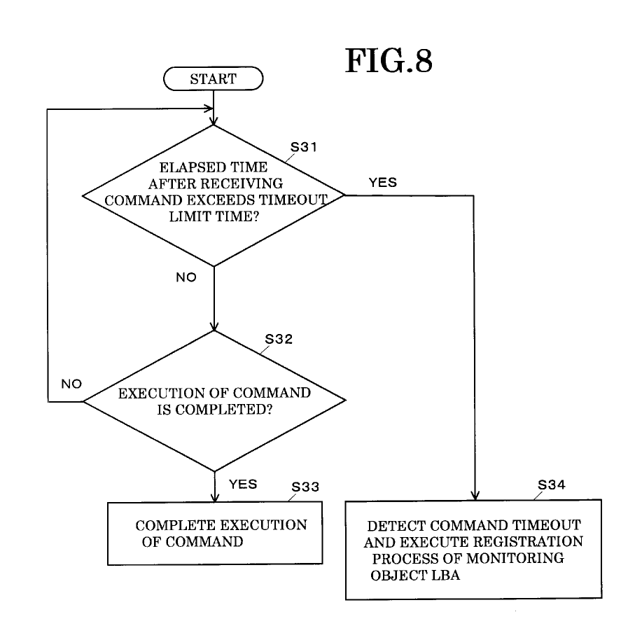

When the control unit 10 determines that the execution of the command is not completed in the step S6, the control unit 10 executes the command timeout detection process as will be described with reference to FIG. 8 (step S11).

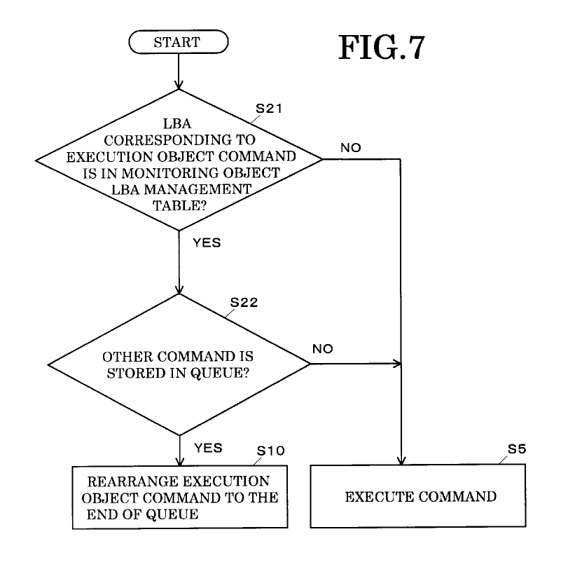

FIG. 7 is a diagram for explaining the detail of the process (command rearrangement process) in step S4 and step S10 in FIG. 6. The process executed in the step S10 and in the step S5 in FIG. 7 is the same as the process executed in the step S10 and in the step S5 in FIG. 6.

First, by referring to the monitoring object LBA management table 104, the control unit 10 determines whether or not the LBA corresponding to the execution object command exists in the monitoring object LBA management table 104 (step S21). When the control unit 10 determines that no LBA corresponding to the execution object command exists in the monitoring object LBA management table 104, the process proceeds to step S5 and the control unit 10 executes the command. When the control unit 10 determines that the LBA corresponding to the execution object command exists in the monitoring object LBA management table 104, the control unit 10 determines whether or not the other command to be executed after the execution of the execution object command is stored in the queue 20 (step S22). When the control unit 10 determines that no other command to be executed after the execution of the execution object command is stored in the queue 20, the process proceeds to step S5. When the control unit 10 determines that the other command to be executed after the execution of the execution object command is stored in the queue 20, the process proceeds to step S10 and the control unit 10 rearranges the execution object command at the end of the queue 20.

FIG. 8 is a diagram for explaining the detail of the command timeout detection process in the step S11 in FIG. 6. First, the control unit 10 determines whether or not the elapsed time after receiving the command exceeds a predetermined limit time (timeout limit time) (step S31). When the control unit 10 determines that the elapsed time after receiving the command does not exceed the timeout limit time, the control unit 10 determines whether or not the execution of the command is completed (step S32). When the control unit 10 determines that the execution of the command is not completed, the control unit 10 returns to step S31. When determining that the execution of the command is completed, the execution of the command is completed (step S33).

When the control unit 10 determines that the elapsed time after receiving the command exceeds the timeout limit time in the step S31, the control unit 10 detects the command timeout and executes registration process of the monitoring object LBA (step S34).

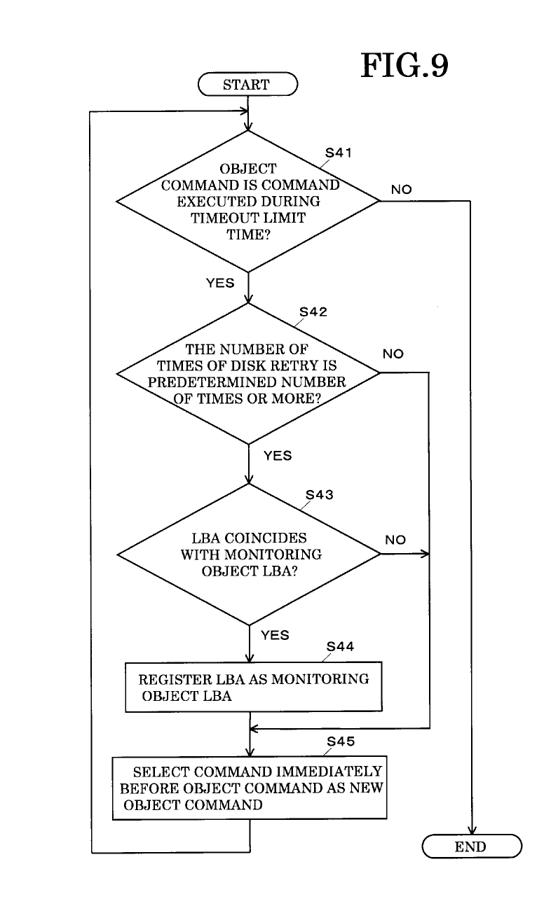

FIG. 9 is a diagram for explaining the detail of the registration process of the monitoring object LBA in step S34 in FIG. 8. First, the control unit 10 selects, as an object command, the command executed immediately before the execution of the command during which execution the command timeout was detected, from among the commands executed before the execution of the command during which execution the command timeout was detected, and determines whether or not the object command is a command executed during the timeout limit time of the command during which the command timeout was detected (step S41). For example, there is assumed a case where the commands of CMD#1, CMD#2 and CMD#3 are respectively executed in this order, and where the command timeout is detected during the execution of the command CMD#3. The control unit 10 selects, as the object command, the command CMD#2 executed immediately before the command CMD#3 is executed, and determines whether or not the command CMD#2 is a command executed during the timeout limit time of the command CMD#3.

When the control unit 10 determines that the object command is not the command executed during the timeout limit time, the process ends. When the control unit 10 determines that the object command is the command executed during the timeout limit time, the control unit 10 determines whether or not the number of times of the occurrence of disk retry during the execution of the object command is the predetermined number of times or more (step S42). When the control unit 10 determines that the number of times of disk retry generated during the execution of the object command is less than the predetermined number of times, the process proceeds to step S45. When the control unit 10 determines that the number of times of disk retry generated during the execution of the object command is the predetermined number of times or more, the control unit 10 determines whether or not the LBA corresponding to the object command coincides with the monitoring object LBA already registered in the monitoring object LBA management table 104 (step S43). When the control unit 10 determines that the LBA corresponding to the object command coincides with the monitoring object LBA already registered in the monitoring object LBA management table 104, the process proceeds to step S45. When the control unit 10 determines that the LBA corresponding to the object command does not coincide with the monitoring object LBA already registered in the monitoring object LBA management table 104, the control unit 10 registers, as the monitoring object LBA, the LBA corresponding to the object command in the monitoring object LBA management table 104 (step S44). Then, the control unit 10 selects the command executed immediately before the object command as a new object command (step S45), and the process returns to the step S41.

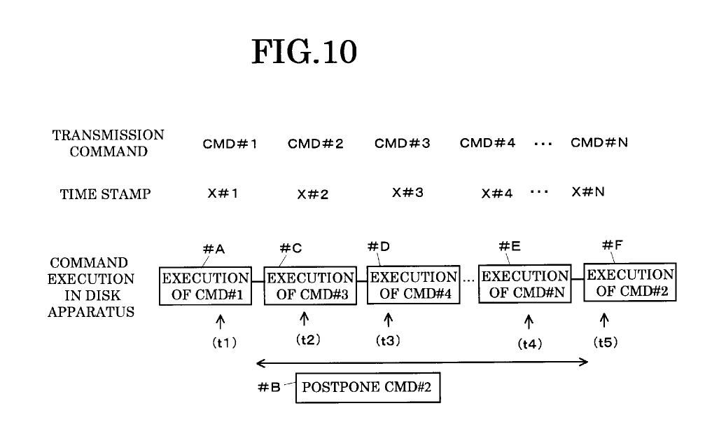

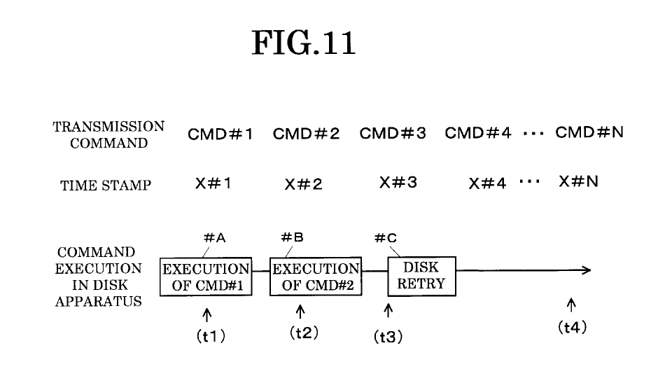

FIG. 10 is a diagram illustrating an example of application of the command processing method executed by the disk apparatus according to the present embodiment. Commands of CMD#1 to CMD#N and time stamps of X#1 to X#N in the diagram are the same as the commands of CMD#1 to CMD#N, the time stamps of X#1 to X#N as described with reference to FIG. 11, respectively. Further, it is assumed that the LBA corresponding to CMD#2 is the monitoring object LBA.

After executing CMD#1 at time t1 (see #A in FIG. 10), the disk apparatus 1 according to the present embodiment postpones the execution of CMD#2 by rearranging CMD#2 at the end of the queue 20 (see #B in FIG. 10), and successively executes CMD#3 and CMD#4 at time t2 and time t3, respectively (see #C and #D in FIG. 10). Then, the disk apparatus 1 executes CMD#N at time t4 (see #E in FIG. 10), and starts the execution of CMD#2 only when only CMD#2 is stored in the queue 20 (time t5) (see #F in FIG. 10). When the disk apparatus 1 executes the command processing as described with reference to FIG. 10, the commands other than CMD#2, which is a command corresponding to the LBA with a large number of times of the occurrence of disk retry, are executed. Therefore, it is possible to suppress the number of times of the occurrence of timeout for the commands other than CMD#2.

The disk apparatus and the command processing method of the present embodiment postpone the processing of the command corresponding to the logical block address (LBA) at which the number of times of occurrence of the disk retry exceeds a predetermined number of times, by rearranging the command at the end of the queue. Therefore, according to the disk apparatus and the command processing method of the present embodiment, a command corresponding to an LBA (normal LBA), at which the number of times of occurrence of the disk retry is small and at which a response is more likely to be normally returned, is preferentially executed. Therefore, the accumulated number of times of the command timeout generated by the host can be significantly reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that the various changes, substitutions, and alterations could be made hereto without departing from the spirit and scope of the invention.

What is claimed is:

1. A disk apparatus comprising:
a first storage unit; and
a control unit that stores the command in a queue and taking out a command stored at the top of the queue to execute the taken-out command as an execution object command,
the control unit monitors a stay time of the command stored in the queue, in the control unit, stores, when the execution of the command is not completed within a predetermined time, a logical block address corresponding to a command which is executed within the predetermined time and during execution of which disk retry is generated more than a predetermined number of times, as a monitoring object address in first storage unit,
the control unit determines whether or not a command to be executed after the execution of the execution object command is stored in the queue, and determines, when the control unit determines that the command to be executed after the execution of the execution object command is stored in the queue, whether or not the logical block address corresponding to the execution object command corresponds to the monitoring object address stored in the first storage unit, and the control unit rearranges, when the control unit determines that the logical block address corresponding to the execution object command corresponds to the monitoring object address stored in the first storage unit command, the command in the position at the end of the queue.

2. The disk apparatus according to claim 1, wherein the control unit selects, when the control unit determines that the logical block address corresponding to the execution object command corresponds to the monitoring object address stored in the first storage unit, a command which has a command type different from the command type of the execution object command and which is stored in the queue corresponding to a logical block address overlapping with the monitoring object address, as a selection command from among the commands stored in the queue, and rearranges the execution object command in the position immediately before the selection command in the queue.

3. The disk apparatus according to claim 1, wherein the control unit stores the monitoring object address in a second nonvolatile storage unit.

4. The disk apparatus according to claim 2, wherein the control unit stores the monitoring object address in a second nonvolatile storage unit.

5. A command processing method in a disk apparatus including a disk and control unit executing a command to the disk, comprising:
in the control unit, storing the command in a queue, and taking out a command stored at the top of the queue to execute the taken-out command as an execution object command, monitoring a stay time of the command stored in the queue, in the control unit, and storing, when the execution of the command is not completed within a predetermined time, a logical block address corresponding to a command which is executed within the predetermined time and during execution of which disk retry is generated more than a predetermined number of times, as a monitoring object address in first storage unit, determining whether or not a command to be executed after the execution object command is stored in the queue, and determining, when the control unit determines that the command to be executed after the execution object command is stored in the queue, whether or not the logical block address corresponding to the execution object command corresponds to the monitoring object address stored in the first storage unit, and rearranging, when the control unit determines that the logical block address corresponding to the execution object command corresponds to the monitoring object address stored in the first storage unit, the command in the position at the end of the queue.

6. The command processing method according to claim 5, wherein, in the control unit, selecting, when the control unit determines that the logical block address corresponding to the execution object command corresponds to the monitoring object address stored in the first storage unit command, a command which has a command type different from the command type of the execution object command and which is stored in the queue corresponding to a logical block address overlapping with the monitoring object address, as a selection command from among the commands stored in the queue, and rearranging the execution object command in the position immediately before the selection command in the queue.

7. The command processing method according to claim 5, wherein, in the control unit, storing the monitoring object address in a second nonvolatile storage unit.

8. The command processing method according to claim 6, wherein, in the control unit, storing the monitoring object address in a second nonvolatile storage unit.
